(19) United States
(12) Patent Application Publication
(10) Pub. No.: US 2020/0089291 A1
(43) Pub. Date: Mar. 19, 2020

(54) Notebook heat dissipation bracket

(71) Applicant: Yudong Zhu, Wuhan City (CN)

(72) Inventor: Yudong Zhu, Wuhan City (CN)

(21) Appl. No.: 16/690,127

(22) Filed: Nov. 21, 2019

(51) Int. Cl. G06F 1/20

(52) U.S. Cl. CPC G06F 1/203

(57) ABSTRACT

The invention discloses a notebook heat dissipation bracket, which comprises a placement board. When the heat dissipation bracket is used, the support tube is extracted, and then the support tube is rotated and the support tube is inserted into the support slot. The support tube supports the fixing plate, the bracket can be placed on the bed for use, supported by the support tube, and the height of the entire heat dissipation bracket can be adjusted by the adjustment mechanism to meet the needs of more users, and can also be adjusted by the rotating mechanism. The angle of the notebook.

### CROSS-REFERENCES TO RELATED APPLICATIONS

The present application claims priority from Chinese application No. 2019103376353 filed on Apr. 25, 2019 which is hereby incorporated by reference in its entirety.

### TECHNICAL FIELD

The present invention relates to the field of bracket, in particular to a notebook heat dissipation bracket.

### BACKGROUND OF THE INVENTION

The general notebook heat dissipation bracket can only be placed on the desktop, can not be placed on the bed, can not adjust the height of the bracket, so as to adjust the height of the notebook, and can not adjust the support angle of the bracket, has many limitations.

### BRIEF SUMMARY OF THE INVENTION

It is an object of the present invention to provide a notebook heat sink bracket for overcoming the above-discussed deficiencies in the prior art.

A notebook heat dissipating bracket according to an embodiment of the present invention includes a placing board, a front side end surface of the placing board is symmetrically disposed with a fan cavity opening outward, and a front side inner wall of the fan cavity is fixedly mounted with a filter screen, the fan cavity The rear side is provided with an engaging cavity, and the power rod is rotated and matched with the second bevel gear to install a power rod. The front side end surface of the power rod is fixedly mounted with three blades, and the inner wall of the fan chamber is provided with four inner walls. An air outlet extending through a rear end surface of the placing plate, a rear side end surface of the power rod is fixedly mounted with a first bevel gear, and a right side inner wall of the right side of the engaging cavity is fixedly mounted with a motor, and the motor outputs to the left The left end surface of the shaft is fixedly mounted with a transmission rod penetrating through the right inner wall of the engagement cavity on the left side, and the second bevel gear is fixedly mounted on the transmission rod in a left-right direction, the second bevel gear and the first bevel gear Engaging, when the notebook needs to dissipate heat from the notebook, the motor starts to rotate the transmission rod, the transmission rod rotates to drive the second bevel gear to rotate, and the second bevel gear passes the first bevel gear Rotating the power rod to rotate, the power rod rotating to drive the fan blade to rotate, the blade sucking hot air from the front side of the fan cavity, and then sending out from the air outlet, the rear side of the placing plate is set There is a fixing plate, and a supporting mechanism for supporting is disposed on the left side of the fixing plate, and a rotating mechanism capable of rotating the placing plate is disposed under the placing plate, and the rear side of the fixing plate is provided to adjust the entire notebook An adjusting mechanism for the height of the heat dissipating bracket, the adjusting mechanism comprising a fixing platform placed on the ground, and the front end surface of the fixing table is rotatably fitted with a rotating block that is powered by the adjusting mechanism.

In a further technical solution, the support mechanism further includes a sliding slot symmetrically disposed in the fixing plate, and a slot is formed on the left side of the fixing plate, and the supporting slot is slidably fitted in the sliding slot. The sliding groove is connected to the limiting groove. The limiting groove is slidably fitted with a limiting rod. The limiting rod is rotatably mounted with the supporting tube. The front side of the limiting groove is connected with a supporting groove, and the supporting tube is right. The end face can be snapped into the support groove.

In a further technical solution, the rotating mechanism further includes an auxiliary cavity disposed on a rear side of the placing plate in the fixing plate, and a connecting cavity is disposed under the auxiliary cavity, and the connecting cavity rotates between the left and right inner walls Cooperating with the installation of the rotating rod, the connecting rod is fixedly mounted on the rotating rod, the connecting block is fixedly connected with the placing plate, and the rear end surface of the placing plate is provided with an opening cavity extending rearward, and the sliding cavity is matched with the sliding cavity The pulling block is mounted, and the auxiliary block is rotatably mounted in the pulling block, and the U-shaped auxiliary pipe is fixedly mounted on the auxiliary rod, and the moving groove is connected to the front side of the pulling cavity, and the moving block is slidably fitted in the moving groove The moving block is fixedly connected to the pulling block, and the connecting plate is fixedly mounted between the upper and lower inner walls of the auxiliary cavity, and the front end surface of the connecting plate is provided with an adjusting cavity, and the auxiliary pipe can be inserted into the adjusting cavity.

In a further technical solution, the adjusting mechanism further includes a threaded rod fixedly mounted on the front end surface of the rotating block, the rear side end surface of the fixing plate is rotatably fitted to the lifting block, and the rear end surface of the lifting block is provided with an opening backward. a threaded hole, the threaded hole being threadedly mounted with the threaded rod.

The invention has the beneficial effects that the bracket can be placed on the bed for use, supported by the support tube, and the height of the entire heat dissipation bracket can be adjusted by the adjustment mechanism to meet the needs of more users, and can also be adjusted by the rotating mechanism. The angle of placing the notebook is worth promoting.

### BRIEF DESCRIPTION OF THE DRAWINGS

FIG. 1 is a schematic view of the structure of the present invention;

FIG. 2 is a cross-sectional structural view of the A-A direction of FIG. 1;

FIG. 3 is a schematic bottom view of the present invention;

FIG. 4 is a cross-sectional structural view taken along line B-B of FIG. 1;

FIG. 5 is a cross-sectional structural view taken along line C-C of FIG. 1.

### DETAILED DESCRIPTION OF THE INVENTION

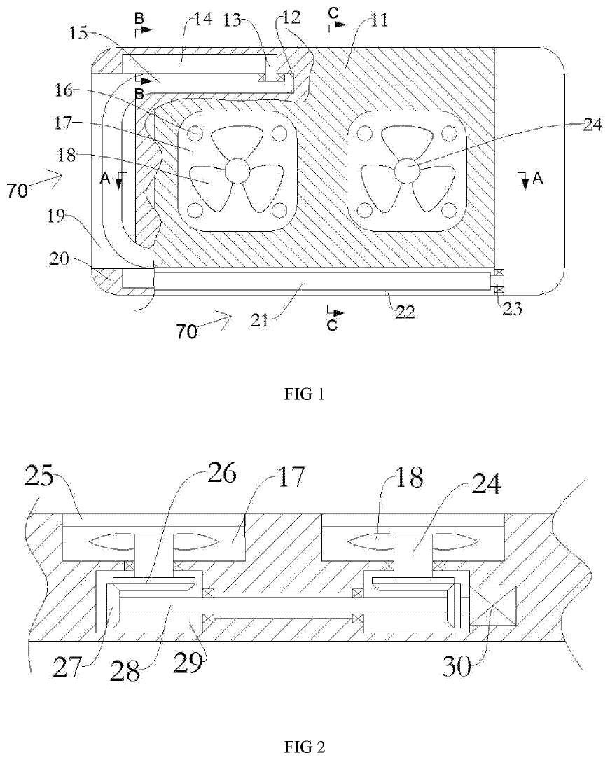

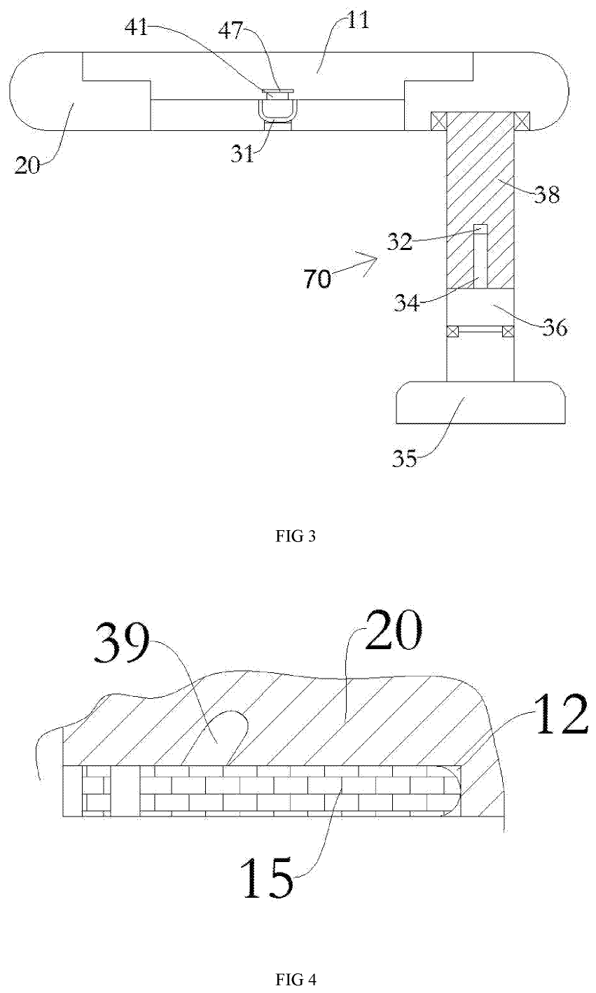

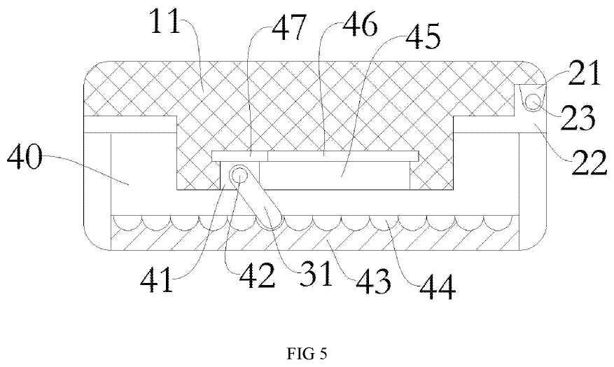

The present invention will now be described in detail with reference to FIGS. 1-5. For the convenience of description, the orientations described below are now defined as follows: the up, down, left, and right front and rear directions described below are consistent with the up, down, left, and right front and rear directions of the projection relationship of FIG. 1 itself.

FIG. 1-5, a notebook heat dissipating bracket according to an embodiment of the present invention includes a placing board 11, and a front side end surface of the placing board 11 is symmetrically disposed with a fan chamber 17 opening forward, and the fan chamber 17 is front. The side wall of the side wall is fixedly mounted with a meshing chamber 29, and the rear side of the fan chamber 17 is provided with an engaging cavity 29, and the power rod 24 is rotatably fitted between the engaging cavity 29 and the second bevel gear 27, and the front side of the power rod 24 Three blades 18 are fixedly mounted on the end surface, and the inner wall of the rear side of the fan cavity 17 is provided with four air outlets 16 extending through the rear end surface of the placing plate 11, and the rear end surface of the power rod 24 is fixedly mounted with the first bevel gear 26. a motor 30 is fixedly mounted on the right inner wall of the engaging cavity 29 on the right side, and the motor 30 is fixedly mounted to the left end surface of the left output shaft to fix the transmission rod of the right inner wall of the engaging cavity 29 on the left side. 28, the second bevel gear 27 is fixedly mounted on the left and right sides of the transmission rod 28, and the second bevel gear 27 meshes with the first bevel gear 26. When the notebook needs to dissipate heat, the motor 30 starts to drive. The transmission rod 28 rotates, and the transmission rod 28 rotates to drive the first The bevel gear 27 rotates, the second bevel gear 27 rotates with the first bevel gear 26 to drive the power rod 24 to rotate, and the power rod 24 rotates to drive the blade 18 to rotate, the blade 18 The hot air is taken in from the front side of the fan chamber 17, and then sent out from the air outlet 16, and the rear side of the placing plate 11 is provided with a fixing plate 20, and the left side of the fixing plate 20 is provided with a supporting mechanism for supporting 70. A rotating mechanism 80 is disposed under the placing plate 11 for rotating the placing plate 11. The adjusting plate 20 is provided with an adjusting mechanism 90 for adjusting the height of the entire notebook heat dissipating bracket. The adjusting mechanism 90 includes A fixing table 35 placed on the ground, the front end surface of the fixing table 35 is rotatably fitted to a rotating block 36 that is powered by the adjusting mechanism 90.

The supporting mechanism 70 further includes a sliding slot 12 symmetrically disposed in the fixing plate 20, and a slot 19 is formed on the left side of the fixing plate 20, and the sliding slot 12 is slidably fitted to the supporting tube 15. The sliding slot 12 is connected with a limiting slot 14. The limiting slot 14 is slidably fitted with a mounting limiting rod 13. The limiting rod 13 is rotatably mounted with the supporting tube 15, and the front side of the limiting slot 14 is connected to the front side. The support groove 39, the right end surface of the support tube 15 can be inserted into the support groove 39, so that when the heat dissipation bracket is used, the support tube 15 is withdrawn, and then the support tube 15 is rotated and the support tube 15 is inserted into the support groove 39. The fixing plate 20 can be supported by the support tube 15.

The rotating mechanism 80 further includes an auxiliary cavity 40 disposed on the rear side of the mounting plate 11 in the fixing plate 20, and a connecting cavity 22 is disposed below the auxiliary cavity 40, and the left and right inner walls of the connecting cavity 22 are The rotating rod 23 is fixedly mounted, and the connecting rod 21 is fixedly mounted on the rotating rod 23, the connecting block 21 is fixedly connected with the placing plate 11, and the rear end surface of the placing plate 11 is provided with an opening chamber with an opening rearward 45. The pulling chamber 45 is slidably fitted with a pulling block 41. The pulling block 41 is rotatably fitted with an auxiliary lever 42. The auxiliary rod 42 is fixedly mounted with a U-shaped auxiliary tube 31. The front side of the pulling chamber 45 The moving slot 46 is slidably coupled to the moving block 47. The moving block 47 is fixedly connected to the pulling block 41. The connecting plate 43 is fixedly mounted between the upper and lower inner walls of the auxiliary cavity 40. The front end surface of the connecting plate 43 is provided with an adjusting cavity 44, and the auxiliary pipe 31 can be inserted into the adjusting cavity 44, thereby adjusting the angle of the placing plate 11, manually rotating the placing plate 11, and then moving the pulling block 41, and The auxiliary tube 31 is snapped into the adjustment chamber 44 for support.

The adjusting mechanism 90 further includes a threaded rod 34 fixedly mounted on the front end surface of the rotating block 36. The rear end surface of the fixing plate 20 is rotatably fitted to the lifting block 38, and the rear end surface of the lifting block 38 is provided with an opening direction. a threaded hole 32, the threaded hole 32 is threadedly mounted with the threaded rod 34, so that when the height of the entire notebook heat sink bracket needs to be adjusted, the lifting block 38 is first grasped, and then the rotating block 36 is rotated to drive the threaded rod 34 to rotate. The lifting block 38 is moved up and down.

In use, when the notebook needs to dissipate heat, the motor 30 starts to rotate the transmission rod 28, the transmission rod 28 rotates to drive the second bevel gear 27 to rotate, and the second bevel gear 27 passes The first bevel gear 26 meshes to rotate the power rod 24, the power rod 24 rotates to drive the blade 18 to rotate, and the blade 18 sucks hot air from the front side of the fan cavity 17, and then When the air outlet 16 is sent out, the support tube 15 is taken out, and then the support tube 15 is rotated and the support tube 15 is inserted into the support groove 39. The support tube 15 can be used to support the fixed plate 20, and the angle of the placement plate 11 can be adjusted. When the plate 11 is manually rotated, the pulling block 41 is moved, and the auxiliary tube 31 is snapped into the adjustment cavity 44 for support. When it is necessary to adjust the height of the entire notebook heat sink bracket, the lifting block 38 is first grasped, and then rotated. Block 36 causes the threaded rod 34 to rotate, causing the lift block 38 to move up and down.

The invention has the beneficial effects that the bracket can be placed on the bed for use, supported by the support tube, and the height of the entire heat dissipation bracket can be adjusted by the adjustment mechanism to meet the needs of more users, and can also be adjusted by the rotating mechanism. The angle of placing the notebook is worth promoting.

It will be apparent to those skilled in the art that various modifications of the above embodiments can be made without departing from the spirit and scope of the invention. They all fall within the scope of protection of the present invention. The protection of the invention is subject to the claims appended hereto.

1. A notebook heat dissipation bracket, comprising a placing board, wherein: a front side end surface of the placing board is symmetrically disposed with a fan cavity opening outward, and a front side inner wall of the fan cavity is fixedly mounted with a filter screen, and the fan cavity is rearward The side is provided with an engaging cavity, and the power rod is rotated and matched with the second bevel gear to install a power rod. The front side end surface of the power rod is fixedly mounted with three blades, and the inner wall of the fan chamber is provided with four inner walls. a first bevel gear is fixedly mounted on the rear end surface of the power rod, and a motor is fixedly mounted on the right inner wall of the right side of the meshing chamber, and the output shaft of the motor is leftward. a left side end surface fixedly mounting a transmission rod penetrating through a right inner wall of the engagement cavity on the left side, wherein the transmission rod is fixedly mounted to the second bevel gear symmetrically, and the second bevel gear meshes with the first bevel gear When the heat dissipation of the notebook is required, the motor starts to rotate the transmission rod, the rotation of the transmission rod drives the rotation of the second bevel gear, and the second bevel gear passes through the belt with the first bevel gear. The power rod rotates, the power rod rotates to drive the fan blade to rotate, the blade sucks hot air from the front side of the fan cavity, and then sends out from the air outlet, and the rear side of the placement plate is fixed a supporting mechanism for supporting the left side of the fixing plate, and a rotating mechanism for rotating the placing plate is disposed under the placing plate, and the rear side of the fixing plate is provided with a cooling bracket capable of adjusting the entire notebook A high and low adjustment mechanism includes a fixed platform placed on the ground, and the front end surface of the fixed table is rotatably fitted with a rotating block that is powered by the adjustment mechanism.

2. The notebook heat dissipation bracket according to claim 1, wherein the support mechanism further comprises a sliding slot symmetrically disposed in the fixing plate, and a slot is connected to the left side of the fixing plate. The sliding groove is slidably fitted to the supporting tube, the sliding groove is connected with a limiting groove, the limiting groove is slidably fitted with a limiting rod, and the limiting rod is rotatably mounted with the supporting tube, the limiting groove The front side is connected with a support groove, and the right end surface of the support tube can be inserted into the support groove. When the heat dissipation bracket is used, the support tube is pulled out, then the support tube is rotated and the support tube is inserted The support plate can support the fixing plate in the support groove.

3. The notebook heat dissipation bracket according to claim 1, wherein the rotating mechanism further comprises an auxiliary cavity disposed on a rear side of the placing plate in the fixing plate, and the auxiliary cavity is connected below. a connecting cavity is provided, and a rotating rod is rotatably mounted between the left and right inner walls of the connecting cavity, and the connecting rod is fixedly mounted on the rotating rod, and the connecting block is fixedly connected with the placing plate, and the rear end surface of the placing plate is provided Opening a rearward pulling chamber, the pulling chamber is slidably fitted with a pulling block, the pulling block is rotatably fitted with an auxiliary rod, and the auxiliary rod is fixedly mounted with a U-shaped auxiliary tube, and the front side of the pulling chamber is connected There is a moving slot, the moving slot is slidably fitted with a moving block, the moving block is fixedly connected with the pulling block, and a connecting plate is fixedly mounted between the upper and lower inner walls of the auxiliary cavity, and the front side end surface of the connecting plate is provided with an adjusting cavity The auxiliary tube may be inserted into the adjustment cavity, when the angle of the placement plate is adjusted, the placement plate is manually rotated, then the pulling block is moved, and the auxiliary tube is inserted into the The adjustment chamber is used for support.

4. The notebook heat dissipation bracket according to claim 1, wherein the adjusting mechanism further comprises a threaded rod fixedly mounted on an end surface of the front side of the rotating block, and a rear side end surface of the fixing plate is rotatably mounted to be lifted and lowered. Block, the rear end surface of the lifting block is provided with a threaded hole with an opening rearward, and the threaded hole is threadedly mounted with the threaded rod. When it is necessary to adjust the height of the entire notebook heat sink bracket, the lifting block is first grasped. Then rotating the rotating block drives the threaded rod to rotate, so that the lifting block moves up and down.
